(19) United States
(12) Patent Application Publication
(10) Pub. No.: US 2026/0125789 A1
(43) Pub. Date: May 7, 2026

(54) MANUFACTURING PROCESS WITH REDUCED TRANSPORT OF METAL IONS, MANUFACTURED PRODUCTS, AND STORED PRODUCTS

(71) Applicant: SILCOTEK CORP., Bellefonte, PA (US)

(72) Inventors: Jesse BISCHOF, Bellefonte, PA (US); Kevin MORRISON, Pleasant Gap, PA (US); Geoffrey K. WHITE, State College, PA (US); Lucas D. PATTERSON, Altoona, PA (US)

(21) Appl. No.: 18/686,159

(22) PCT Filed: Aug. 24, 2022
(86) PCT No.: PCT/US2022/041295

§ 371 Date: Feb. 23, 2024

Related U.S. Application Data
(60) Provisional application No. 63/237,833, filed on Aug. 27, 2021.
(60) Provisional application No. 63/278,717, filed on Nov. 12, 2021.

(51) Int. Cl. C23C 16/06

(52) U.S. Cl. CPC C23C 16/06

(57) ABSTRACT

Manufacturing processes, manufactured products, and stored products are disclosed. The manufacturing processes include contacting a surface with a fluid, the surface being on a metallic substrate, and producing a product from the manufacturing process. Transport of metal ions from the metallic substrate are reduced or eliminated from reaching the fluid. The manufactured products are produced by the manufacturing process. The stored products including a fluid and metal ions at a concentration of less than 50 ppb.

### PRIORITY

The present application is an international Patent Cooperation Treaty (PCT) patent application claiming priority and benefit of U.S. Provisional Patent Application No. 63/237,833, entitled “FOOD AND BEVERAGE DEVICES, PRODUCTION PROCESSES, AND PRODUCTION SYSTEMS,” filed Aug. 27, 2021, and U.S. Provisional Patent Application No. 63/278,717, entitled “MANUFACTURING PROCESS, MANUFACTURING PRODUCTS, AND STORED PRODUCTS,” filed Nov. 12, 2021, both of which are incorporated by reference in their entirety.

### FIELD OF THE INVENTION

The present invention is manufacturing processes, manufactured products, and stored products. More particularly, the present invention is directed to such processes and products impacted by reduced or eliminated metal ions.

### BACKGROUND OF THE INVENTION

Nearly all organic acids are produced at industrial scale via microbial fermentation. Many factors such as time, temperature, and concentration of ingredients have been considered to improve the acid production. One factor that is considered is the metal ion concentrations of various metallic elements. In the 1960s processes were developed for removing metal ions from raw materials; however, metal ions continue to be introduced.

Some metal ions are introduced through substrates, such as, stainless steel. The metal ions are present on pumps, tubing/pipes, fittings, and other surfaces that contact materials used in the process and/or products made through such processes.

Manufacturing processes, manufactured products, and stored products that shows one or more improvements in comparison to the prior art would be desirable in the art.

### BRIEF DESCRIPTION OF THE INVENTION

In an embodiment, a manufacturing process includes contacting a surface with a fluid, the surface being on a metallic substrate, and producing a product from the manufacturing process. Transport of metal ions from the metallic substrate are reduced or eliminated from reaching the fluid.

In another embodiment, a manufactured product produced by a manufacturing process, the manufacturing process including contacting a surface with a fluid, the surface being on a metallic substrate, and producing a product from the manufacturing process. Transport of metal ions from the metallic substrate are reduced or eliminated from reaching the fluid.

In another embodiment, a stored product including a fluid and metal ions at a concentration of less than 50 ppb.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a production process, according to an exemplary embodiment of the disclosure.

FIG. 2 shows examples from production processes illustrating differences between comparative output products and the desired output product, according to an exemplary embodiment of the disclosure.

Wherever possible, the same reference numbers will be used throughout the drawings to represent the same parts.

### DETAILED DESCRIPTION OF THE INVENTION

Provided are manufacturing processes, manufactured products, and stored products. Embodiments of the present disclosure, for example, in comparison to concepts failing to include one or more of the features disclosed herein, reduce metal ion concentrations, enable stability (with or without stabilizers), extend shelf-life (with or without preservatives), modify phenolic composition, modify polyphenolic composition, modify antioxidant activity, allow different foodstuff compositions, extend operational durations of production, reduce or eliminate cleaning cycles, increase yield, or a combination thereof.

Embodiments of the present disclosure include any suitable techniques, systems, and components including one or more metal surface capable of being coated through thermal chemical vapor deposition to have a thermal chemical vapor deposition coating on a substrate of a device. Further embodiments of the present disclosure encompass food and beverage device and production processes susceptible to metal ion contamination. Countless at least partially compatible techniques exist for storing and processing food and beverages, for example, U.S. Patent Application Publication No. 2009/0148556, filed Mar. 22, 2006, and entitled “BREWERY PLANT AND METHOD,”, which is incorporated by reference in its entirety.

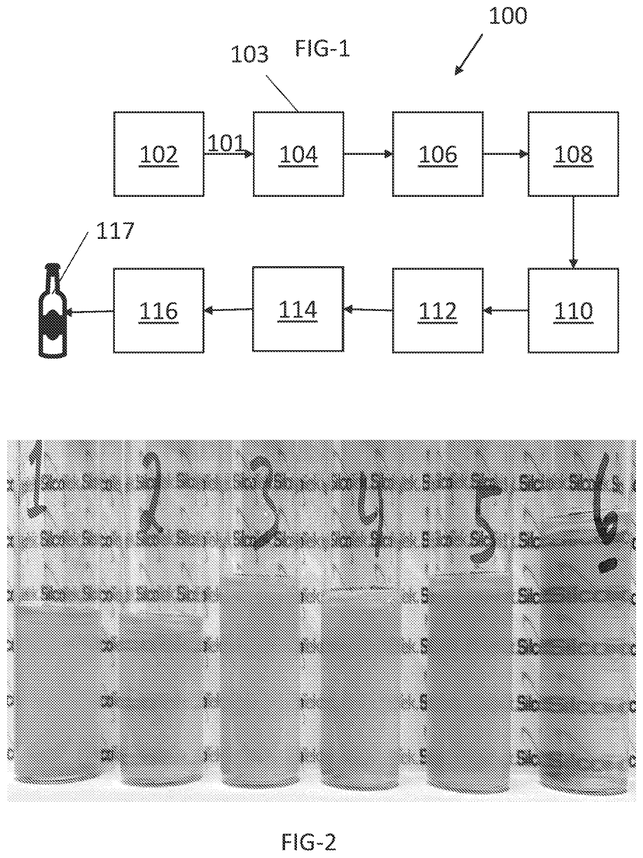

Referring to FIG. 1, in one embodiment, a production process 100 is shown. The process includes introducing (step 102) one or more foodstuff materials 101 to a system 103, for example, through milling, pouring, injecting, dumping, mixing, or other suitable techniques. The term “foodstuff” is intended to encompass constituents of food, beverages, and other caloric items appropriate for human consumption. Exemplary embodiments include the foodstuff materials 101 being or including a fluid, such as, condiments (for example, ketchup, mustard, mayonnaise, hot sauce, and relish) dressing, oil, wine, coffee, tea, wine vinegar, vinegar, beer (for example, ales, lagers, stouts, and ports), yogurt, milk, soy milk, butter, artificial butter, peanut butter, syrup, soup, soy sauce, vodka, whiskey, scotch, soda (pop), baby formula, protein drinks/shakes, cola, spritzers, potable water, or combinations thereof.

The foodstuff material(s) 101 are processed (step 104), for example, through mashing (step 106), for example, in a masher 105, boiling (step 108), for example, in a kettle 107, fermenting (step 110), for example, in a fermenting tank 109, filtering (step 112), for example, in a filtration unit 111, carbonating (step 114), for example, in a tank 113, and storing (step 116), for example, in a storage container 117, such as a bottle, can, keg, or other beverage storage container 117. As will be appreciated by those skilled in the art, certain steps may be omitted, duplicated, reordered, or added based upon the desired output product (not shown).

Embodiments of the disclosure include the desired output product from the beverage production process and/or the food production process being or including baby formula, fish oil, milk, mayonnaise, beef patties, wine, beer, or other foodstuff susceptible to metal ions (for example, being prone to oxidation from iron or copper ions, such as omega-3-fatty acids), solvents, ion leaching, chelating, or combinations thereof. Additionally or alternatively, embodiments include the desired output having antioxidants, proteins, lipids, or combinations thereof. In one embodiment, the desired output is devoid or substantially devoid of metal ions. In further embodiments, the desired output is devoid of preservatives that are traditionally added to foodstuffs for binding metal ions (for example, through metal chelators, such as, lactoferrin, apotransferrin, phytic acid, EDTA, potato proteins, added sulfites) and/or filtering metal ions.

The substrate is any material capable of being processed in a thermal chemical vapor deposition process. As used herein, the phrase “thermal chemical vapor deposition” refers to a reaction and/or decomposition of one or more gases, for example, in a starved reactor configuration, and is distinguishable from plasma-assisted chemical vapor deposition, radicalinitiated chemical vapor deposition, catalyst-assisted chemical vapor deposition, sputtering, atomic layer deposition (which is limited to a monolayer molecular deposition per cycle in contrast being capable of more than one layer of molecular deposition), and/or epitaxial growth (for example, growth at greater than 700° C.). For example, suitable substrates are resistant to thermal conditions of greater than 200° C., greater than 300° C., greater than 350° C., greater than 370° C., greater than 380° C., greater than 390° C., greater than 400° C., greater than 410° C., greater than 420° C., greater than 430° C., greater than 440° C., greater than 450° C., greater than 500° C., between 300° C. and 450° C., between 350° C. and 450° C., between 380° C. and 450° C., between 300° C. and 500° C., between 400° C. and 500° C., or any suitable combination, sub-combination, range, or sub-range therein.

In one embodiment, the substrate is stainless steel, for example, a 300-series stainless steel (such as, 316 stainless steel, 316L stainless steel, or 304 stainless steel) or 400-series stainless steel. In another embodiment, the substrate is an aluminum alloy, for example, a 1000-series aluminum alloy, a 3000-series aluminum alloy, a 4000-series aluminum alloy, or a 6000-series aluminum alloy. Other suitable types of the substrate include, but are not limited to, Hastelloy®, Inconel®, platinum and platinum alloys, titanium and titanium alloys, and combinations thereof.

The substrate is capable of having any at least partially flexible structure capable of being furled. For example, suitable structures for the substrate include, but are not limited to, metal sheeting, porous, non-porous, woven cloth, perforated foil, a lattice structure, and combinations thereof. As used herein, the term “furled” and grammatical variations thereof, refers to being rolled or wrapped in a coil-like orientation. Examples of furled objects consistent with the definition herein include, but are not limited to, metal coils, bolts of fabric, sails wound around masts, wound wire, and window blinds. The term furled is not intended to be limited to tight winding.

To perform the chemical vapor deposition, a precursor fluid is used. The precursor fluid is a liquid or gas (but not a plasma) and imparts chemical constituents to produce the coating within a chemical vapor deposition chamber. The chemical vapor deposition chamber is an enclosed vessel.

The precursor fluid(s) or functionalizer(s) is/are cycled in a single cycle or multiple cycles, for example, with intermediate purges (for example, with inert gases, such as, nitrogen, helium, and/or argon). Suitable numbers of cycles include two cycles, three cycles, four cycles, five cycles, six cycles, seven cycles, eight cycles, nine cycles, ten cycles, eleven cycles, twelve cycles, thirteen cycles, fourteen cycles, fifteen cycles, sixteen cycles, or any suitable combination, sub-combination, range, or sub-range therein.

The precursor fluid is capable of being one or more of the following fluids: silane, silane and ethylene, silane and an oxidizer, dimethylsilane, dimethylsilane and an oxidizer, trimethylsilane, trimethylsilane and an oxidizer, dialkylsilyl dihydride, alkylsilyl trihydride, nonpyrophoric species (for example, dialkylsilyl dihydride and/or alkylsilyl trihydride), thermallyreacted material (for example, carbosilane and/or carboxysilane, such as, amorphous carbosilane and/or amorphous carboxysilane), species capable of a recombination of carbosilyl (disilyl or trisilyl fragments), methyltrimethoxysilane, methyltriethoxysilane, dimethyldimethoxysilane, dimethyldiethoxysilane, trimethylmethoxysilane, trimethylethoxysilane, ammonia, hydrazine, trisilylamine, Bis(tertiary-butylamino) silane, 1,2-bis(dimethylamino)tetramethyldisilane, dichlorosilane, hexachlorodisilane), organofluorotrialkoxysilane, organofluorosilylhydride, organofluoro silyl, fluorinated alkoxysilane, fluoroalkylsilane, fluorosilane, tridecafluoro 1,1,2,2-tetrahydrooctylsilane, (tridecafluoro-1,1,2,2-tetrahydrooctyl)triethoxysilane, triethoxy (3,3,4,4,5,5,6,6,7,7,8,8,8-tridecafluoro-1-octyl) silane, (perfluorohexylethyl)triethoxysilane, silane (3,3,4,4,5,5,6,6,7,7,8,8,9,9,10,10,10-heptadecafluorodecyl)trimethoxy-, or a combination thereof.

In one embodiment, pure (100%) ethylene is used as a functionalizer of the precursor fluid. Alternatively, ethylene has a concentration, by volume, of greater than 50%, greater than 60%, greater than 70%, greater than 80%, greater than 90%, greater than 95%, greater than 99%, between 60% and 100%, between 80% and 100%, between 90% and 100%, or any suitable combination, sub-combination, range, or sub-range therein. In further embodiments, balances of the precursor fluid are argon, krypton, helium, nitrogen, xenon, hydrogen, or a combination thereof.

In one embodiment, the coating is produced with the partial pressures for the fluid being between 10 Torr and 100 Torr, 10 Torr and 50 Torr, 10 Torr and 300 Torr, 200 Torr and 300 Torr, 100 Torr and 1,500 Torr, between 100 Torr and 300 Torr, between 200 Torr and 400 Torr, between 300 Torr and 500 Torr, between 600 Torr and 800 Torr, between 500 Torr and 1,000 Torr, between 500 Torr and 1,500 Torr, between 1,000 Torr and 1,500 Torr, between 500 Torr and 3,000 Torr, between 1,500 Torr and 2,500 Torr, between 1,000 Torr and 3,500 Torr, less than 1,500 Torr, less than 1,000 Torr, less than 500 Torr, less than 300 Torr, or any suitable combination, sub-combination, range, or sub-range therein.

In one embodiment, the coating is produced with the temperature and the pressure being maintained for at least 10 minutes, at least 20 minutes, at least 30 minutes, at least 45 minutes, at least 1 hour, at least 2 hours, at least 3 hours, at least 4 hours, at least 5 hours, at least 7 hours, between 10 minutes and 1 hour, between 20 minutes and 45 minutes, between 4 and 10 hours, between 6 and 8 hours, between 4 and 20 hours, between 10 and 20 hours, or any suitable combination, sub-combination, range, or sub-range therein.

Suitable thicknesses of the coating include, but are not limited to, between 100 nanometers and 10,000 nanometers, between 100 nanometers and 1,000 nanometers, between 100 nanometers and 800 nanometers, between 200 nanometers and 600 nanometers, between 200 nanometers and 10,000 nanometers, between 500 nanometers and 3,000 nanometers, between 500 nanometers and 2,000 nanometers, between 500 nanometers and 1,000 nanometers, between 1,000 nanometers and 2,000 nanometers, between 1,000 nanometers and 1,500 nanometers, between 1,500 nanometers and 2,000 nanometers, 800 nanometers, 1,200 nanometers, 1,600 nanometers, 1,900 nanometers, or any suitable combination, sub-combination, range, or subrange therein.

Suitable compositions of the coating include the coating being an amorphous silicon coating, a silicon-oxygen-carbon-containing coating, a silicon-nitrogen-containing coating, a silicon-fluorine-carbon-containing coating, or a combination thereof. Further embodiments include the coating having a carbon functionalization.

The device for containing, transporting, processing, or otherwise handling the foodstuff is any article having metal surface that can withstand the thermal chemical vapor deposition process. Suitable geometries of the devices include, but are not limited to, planar, geometrically complex, solid, porous (for example, mesh or filtration media), other configurations having blind holes or portions incapable of being fully coated by line-of-sight techniques, or a combination thereof. In one embodiment, the coating is produced on all exposed surfaces. As used herein, the term “exposed,” with regard to “exposed surfaces,” refers to any surface that is in contact with gas during the process, and is not limited to line-of-sight surfaces or surfaces proximal to line-of-sight directions as are seen in flow-through chemical vapor deposition processes that do not have an enclosed vessel.

Suitable embodiments of the device include, but are not limited to, storage vessels (for example, an article having an open end, a closed end, and a cylindrical portion between, an article having an open end and a spherical and/or round portion, such as, a gas cylinder or an air can), fittings (for example, unions, connectors, adaptors, other connections between two or more pieces of tubing, for example, capable of making a leak-free or substantially leak-free seal), compression fittings (including ferrules, such as, a front and back ferrule), tubing (for example, coiled tubing, tubing sections such as used to connect a sampling apparatus, pre-bent tubing, straight tubing, loose wound tubing, tightly bound tubing, and/or flexible tubing, whether consisting of the interior being treated or including the interior and the exterior being treated), valves (such as, gas sampling, liquid sampling, transfer, shut-off, or check valves, for example, including a rupture disc, stem, poppet, rotor, multi-position configuration, able to handle vacuum or pressure, a handle or stem for a knob, ball-stem features, ball valve features, check valve features, springs, multiple bodies, seals, needle valve features, packing washers, and/or stems), quick-connects, regulators and/or flow-controllers (for example, including o-rings, seals, and/or diaphragms), injection ports (for example, for gas chromatographs), in-line filters (for example, having springs, sintered metal filters, mesh screens, and/or weldments), frits, columns, materials, glass liners, in-line sampling components, components associated with vacuum systems and chambers, drilled and/or machined block components, manifolds, pumps, tanks, heat exchangers, recirculators, or combinations thereof.

The coating reduces or eliminates substrate-introduced metal ions. As used herein, the term “substrate-introduced metal ion(s)” refers to one or more metal ions introduced from a fluid-based product (being predominantly liquid, gas, plasma, or solutions/mixtures thereof) contacting a surface in a container or pathway. The metal ions are any suitable ions, such as, Ca²⁻, Ni²⁺, Mn²⁻, Cu²⁺, Mg²⁻, Zn²⁻, Fe²⁻, as described in Shalini Singh and Robinka Khajuria, New and Future Developments in Microbial Biotechnology and Bioengineering, Chapter 12: Regulation by Metal Ions, 2019 (https://doi.org/10.1016/B978-0-444-63504-4.00012-8), the entirety of which is incorporated by reference.

According to one embodiment of a manufacturing process, the foodstuff material(s) 101 include modified compositions based upon the reduction or elimination of substrate-induced metal ions. In one embodiment, the foodstuff material(s) 101 include lower or no preservatives compared to comparable foodstuff, but the foodstuff material(s) 1010 has equal or longer shelf-life and/or resistance to spoilation.

According to one embodiment of a manufacturing process, products produced, for example, by fermentation, have reduced or eliminated substrate-induced metal ions during or after being produced, for example, based upon processes described in Mirminachi, F., Zhang, A., Roehr, M . . . . Acta Biotechnol. Citric Acid Fermentation and Heavy Metal Ions, 22 (2002) 3-4, 363-373, the entirety of which is incorporated by reference. The products have higher yields and/or concentrations compared to comparable products. Examples of such products include, but are not limited to, antimicrobial agents (for example, using fumaric acid) organic acid (such as, citric acid, itaconic acid, fumaric acid, gluconic acid, oxalic acid, dipicolinic acid, succinic acid, lactic acid, and/or malic acid), siderophores, microbial pigments, vascular permeability factor, hydrogen cyanide, antifungals, antitumors, microorganisms, and combinations thereof.

According to one embodiment of a manufacturing process, products produced, for example, have reduced or eliminated substrate-induced metal ions during or after being produced include, but are not limited to, acidifiers, chelating agents, chemicals, pharmaceuticals, citrate salts, dietary supplements, flavoring agents, preservatives, food, beverages, foodstuffs, food additives, detergents, pigments, toners, cosmetics, coatings, building-blocks (for example, for poly-lactic aid), protein drinks, medicinals, herbal remedies, supplements, and combinations thereof.

According to one embodiment of a manufacturing process, metabolites have reduced or eliminated substrate-induced metal ions during or after being produced. Examples of such metabolites include, but are not limited to, penicillin, streptomycin, spectomycin, rifampicin, tetracycline, kanamycin, erythromycin, cephalosporin, oligomycin, nystatin, amphotericin, apergillic acid, aureofacin, candicidin, griseofulvin, clavulanic acid, astacanthin, monascin, monensin, tylosin, cyclosporin A, rapamycin, tacrolimus, actinomycin D, bleomycin, taxol, doxorubicin, mitomycin C, lovastatin, monacolin, pravastatin, or combinations thereof.

According to one embodiment, a fluid (for example, a liquid, gas, plasma, or combination thereof) contacts the article 101. The substrate of the article having the thermal chemical vapor deposition coating and the substrate include(s) metal ions that generally leach into the fluid in the absence of the coating. For example, in a further embodiment, the substrate is or includes 316 stainless steel having, by weight, up to 2% Mn, up to 0.75% Si, between 16% and 18% Cr, between 2% and 3% Mn, and between 10% and 15% Ni; the fluid contains a lower amount of ions from leaching than would otherwise be present without the coating.

A specific embodiment shows the comparative amount of metal ions, a desired metal ion range, and an amount and/or range according to the disclosure. Comparative amounts include, but are not limited to, 50 ppb, 60 ppb, 70 ppb, 75 ppb, 80 ppb, 90 ppb, or any suitable combination, sub-combination, range-or sub-range therein. Desired metal ion ranges include, but are not limited to, between 50 and 90 ppb, between 50 and 70 ppb, between 70 and 90 ppb, or any suitable combination, sub-combination, range-or sub-range therein. Amounts and/or ranges according to the disclosure include, but are not limited to, less than 80 ppb, less than 75 ppb, less than 70 ppb, less than 60 ppb, less than 50 ppb, between 10 and 50 ppb, between 20 and 50 ppb, between 30 and 50 ppb, between 10 and 40 ppb, between 20 and 40 ppb, between 30 and 40 ppb, between 10 and 30 ppb, between 20 and 30 ppb, between 10 and 20 ppb, between 0 and 10 ppb, between 5 and 10 ppb, between 0 and 5 ppb, between 1 and 5 ppb, between 1 and 3 ppb, between 1 and 2 ppb, less than 1 ppb, between 0.1 ppb and 0.5 ppb, between 0.1 and 0.4 ppb, between 0.2 and 0.4 ppb, between 0.2 and 0.3 ppb, between 0.3 and 0.4 ppb, or any suitable combination, sub-combination, range, or sub-range therein. In one embodiment, the desired metal ion range is based upon reduced or eliminated metal ions, for example, by at least 10%, at least 20%, at least 30%, between 10% and 40%, between 10% and 30%, between 10% and 20%, between 20% and 30%, or any suitable combination, sub-combination, range, or sub-range therein.

Suitable fluids include, but are not limited to, water (including impurities), pure water, deionized water, acid, organic solvents, or combinations thereof.

In one embodiment, having the reduced or eliminated metal ion(s) increases yield. For example, manganese contamination has the potential to decrease yields and slow fermentation. In one embodiment, manganese ions are present at levels that increase yields and/or accelerate fermentation.

In one embodiment, the foodstuff(s) or other products produced by the manufacturing process or stored according to the disclosure have health benefits allowing additional therapeutic uses. For example, in one embodiment, metal surfaces reduce or eliminate the presence of iron ions, thereby allowing individuals with hemachromatosis to imbibe using containers having metal surfaces without increasing chrome content in their blood.

In one embodiment, the reduced or eliminated metal ion(s) accelerate an aging process of the product produced by the manufacturing process. For example, iron impacts colloidal stability (haziness) of liquids, such as beer. Iron also impact foam stability. The reduction of metal ions from iron (or other metal ions, such as those from copper, zinc, nickel, cobalt, and manganese) modifies reactions (for example, by promoting gushing reaction).

In one embodiment, the reduced or eliminated metal ion(s) impact phenolic composition of the product produced by the manufacturing process or stored. High polyphenol concentrations have been identified as leading to better quality beverages (especially beer), more stable sensory properties, and longer shelf life. As an example, 10 mL of beer is combined with 8 mL of carboxymethyl cellulose sodium salt and EDTA solution in a flask and thoroughly mixed. 0.5 mL of an ammonium iron citrate solution is added and again mixed. Finally, 0.5 mL of ammonia is added and distilled water is added to dilute to 50 mL total volume. The mixture is allowed to stand at room temperature for 10 minutes and the absorbance was measured at 600 nm. The absorbance value is then multiplied by 820 to determine the total polyphenolic content in mg/L. The beer from the coated system has total polyphenols of 140 mg/L and the comparative beer from the comparative uncoated system has 120 mg/L.

In some embodiments, polyphenols are increased by at least 20 mg/L, at least 10 mg/L, at least 5 mg/L, at least 5%, at least 10%, at least 15%, or any suitable combination, sub-combination, range, or sub-range therein.

In one embodiment, the reduced or eliminated metal ion(s) impact antioxidant activity of the product produced by the manufacturing process or stored. High Trolox (similar to Vitamin E) is identified as a Trolox Equivalency (TE). The beer from the coated system has 0.89 mmol/L TE and the comparative beer from the comparative uncoated system has 0.55 mmol/L TE.

In some embodiments, antioxidant activity is increased by at least 0.1 mmol/L TE, 0.2 mmol/L TE, 0.3 mmol/L TE, 5%, 10%, 15%, 20%, 25%, or any suitable combination, sub-combination, range, or sub-range therein.

### EXAMPLES

A comparative example and an exemplary example include producing beer (specifically, a light pilsner) from the foodstuff materials 101 using all-in-one small-scale fermenters, incorporating the mashing (step 106) as a mash tun step, a lauter tun step, the boiling (step 108), cooling through a heat exchanger, and the fermenting (step 110).

Referring to FIG. 2, the comparative example shows the foodstuff materials 101 after the lauter tun step (identified as 1 in FIG. 2), after the cooling (identified as 3 in FIG. 2), and after the fermenting (identified as 5 in FIG. 2). The exemplary example shows the foodstuff materials 101 after the lauter tun step (identified as 2 in FIG. 2), after the cooling (identified as 4 in FIG. 2), and after the fermenting (identified as 6 in FIG. 2).

The comparative example includes metal surfaces (stainless steel) without coating. The exemplary example includes metal surfaces (stainless steel) coated according to an embodiment of the disclosure. As shown in FIG. 2, the foodstuff materials 101 produced with the exemplary examples is clearer than the corresponding comparative examples. Although not intending to be bound by theory, it is believed that the clarity is due to a difference in metal concentration, which may or may not impact flavor and/or stability of the beer. Metal ion content measurements using ICP-MS show the reduced metal ions at each stage.

| | Metal Ion | | Metal Ion | | |
|---|---|---|---|---|---|
| | Content | | Content | | Reduced Metal |
| | (uncoated) | | (coated) | | Ion Content |
| Mashing (step 106) | 1207 | ppm | 815 | ppm | 33% |
| Boiling (step 108) | 869 | ppm | 565 | ppm | 35% |
| Fermentation (step 110) | 1527 | ppm | 1144 | ppm | 25% |

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A manufacturing process, comprising:
contacting a surface with a fluid, the surface being on a metallic substrate;
producing a product from the manufacturing process;
wherein transport of metal ions from the metallic substrate are reduced or eliminated from reaching the fluid.

2. The manufacturing process of claim 1, wherein the metal ions are reduced by at least 10%.

3. The manufacturing process of claim 1, wherein the metal ions are reduced by at least 20%.

4. The manufacturing process of claim 1, wherein the metal ions are reduced by at least 30%.

5. The manufacturing process of claim 1, wherein the metallic substrate is stainless steel.

6. The manufacturing process of claim 1, wherein the metal ions are iron ions.

7. The manufacturing process of claim 1, wherein the metal ions are chromium ions.

8. The manufacturing process of claim 1, wherein the metal ions are manganese ions.

9. The manufacturing process of claim 1, wherein the metal ions are calcium ions.

10. The manufacturing process of claim 1, wherein the product is an organic acid.

11. The manufacturing process of claim 1, wherein the product is an antimicrobial agent.

12. The manufacturing process of claim 1, wherein the product is a siderophore.

13. The manufacturing process of claim 1, wherein the product is a microbial pigment.

14. The manufacturing process of claim 1, wherein the product is a vascular permeability factor.

15. The manufacturing process of claim 1, wherein the product is hydrogen cyanide.

16. The manufacturing process of claim 1, wherein the product is an antifungal.

17. The manufacturing process of claim 1, wherein the product is an antitumor.

18. The manufacturing process of claim 1, wherein the product is a microorganism.

19. A manufactured product produced from the manufacturing process of claim 1.

20. A stored product, comprising:
a fluid;
wherein the fluid has metal ions at a concentration of less than 50 ppb.
